(19) United States
(12) Patent Application Publication
(10) Pub. No.: US 2024/0283332 A1
(43) Pub. Date: Aug. 22, 2024

(54) FAILURE SYMPTOM DETECTION DEVICE AND FAILURE SYMPTOM DETECTION METHOD FOR ELECTRIC MOTOR-PROVIDED EQUIPMENT

(71) Applicant: Mitsubishi Electric Corporation, Tokyo (JP)

(72) Inventors: Ken HIRAKIDA, Tokyo (JP); Hiroshi INOUE, Tokyo (JP); Makoto KANEMARU, Tokyo (JP); Yoshiki MATSUI, Tokyo (JP); Takaharu NAKAMURA, Tokyo (JP)

(73) Assignee: Mitsubishi Electric Corporation, Tokyo (JP)

(21) Appl. No.: 18/570,651

(22) PCT Filed: Jun. 21, 2021
(86) PCT No.: PCT/JP2021/023302

§ 371 Date: Dec. 15, 2023

(51) Int. Cl. H02K 11/35; H02P 29/024

(52) U.S. Cl. CPC H02K 11/35; H02P 29/024

(57) ABSTRACT

This failure symptom detection device includes: a diagnosis calculation circuitry which calculates index values for abnormality-presence/absence determination for electric motor-provided equipment, from a detection result of current flowing from a driving device to an electric motor; and a diagnosis determination circuitry which determines presence/absence of abnormality of the electric motor-provided equipment from a calculation result of the diagnosis calculation circuitry. The diagnosis calculation circuitry includes a starting current extraction circuitry which, from detected current, extracts current in an acceleration period until a constant rotational speed is reached after starting of the electric motor, a data generation circuitry which divides current data in the acceleration period extracted by the starting current extraction circuitry, into pieces of data, and a frequency analysis circuitry which performs frequency analysis on each piece of data divided by the data generation circuitry.

### TECHNICAL FIELD

The present disclosure relates to a failure symptom detection device for electric motor-provided equipment and a failure symptom detection method for electric motor-provided equipment.

### BACKGROUND ART

In general, there are various loads using an electric motor as a motive-power source, e.g., a pump, a conveyor belt, and a compressor (hereinafter, such loads are referred to as electric motor-provided equipment). Conventionally, in a case where abnormality has occurred in such electric motor-provided equipment, the abnormality is often diagnosed and determined by senses of a person in a maintenance department. In particular, for electric motor-provided equipment of high importance, diagnosis needs to be performed regularly, leading to increase in labor and cost for maintenance and management.

Accordingly, there has been an increasing interest in technology that makes it possible to monitor electric motor-provided equipment automatically and constantly without depending on person's senses. However, in many cases, constant monitoring for an electric motor is based on the premise that various sensors are attached for each electric motor. Examples of such sensors include a torque meter, an acceleration sensor, and a temperature sensor. As conventional technology, it is proposed that current and voltage signals applied to a stator of an electric motor are analyzed on the basis of detection outputs from the various sensors, whereby a failure symptom of the electric motor-provided equipment is detected (see, for example, Patent Document 1).

### CITATION LIST

### Patent Document

Patent Document 1: Japanese Laid-Open Patent Publication No. 2007-170411

### SUMMARY OF THE INVENTION

### Problem to be Solved by the Invention

However, three-phase currents outputted to the electric motor are likely to be influenced by electric noise due to inverter driving or variations due to an operation mode which changes depending on the load state or the like, for example. Then, electric signals to be used for diagnosis are distorted due to the above influence, so that a noise signal might be erroneously detected. Therefore, failure symptom detection disclosed in Patent Document 1 has a problem that it is difficult to detect abnormality of the electric motor-provided equipment accurately.

The present disclosure has been made to solve the above problem, and an object of the present disclosure is to provide a failure symptom detection device for electric motor-provided equipment and a failure symptom detection method for electric motor-provided equipment that can accurately detect a failure symptom of electric motor-provided equipment while being hardly influenced by noise and without adding an extra sensor.

### Means to Solve the Problem

A failure symptom detection device for electric motor-provided equipment according to the present disclosure is a device for detecting a failure symptom of the electric motor-provided equipment including a load with an electric motor used as a motive-power source and a driving device which supplies power to the electric motor and drives the electric motor, the failure symptom detection device including: a current detection unit which detects current flowing from the driving device to the electric motor; a diagnosis calculation unit which calculates an index value for determination for presence/absence of abnormality of the electric motor-provided equipment, on the basis of a result of detection by the current detection unit; a diagnosis determination unit which determines presence/absence of abnormality of the electric motor-provided equipment on the basis of a result of calculation by the diagnosis calculation unit; and a diagnosis result reporting unit which reports a result of diagnosis determined by the diagnosis determination unit, to outside. The diagnosis calculation unit includes a starting current extraction unit which, from the current detected by the current detection unit, extracts current in an acceleration period until a constant rotational speed is reached after starting of the electric motor, a data generation unit which divides data of the current in the acceleration period extracted by the starting current extraction unit, into plural pieces of data, and a frequency analysis unit which performs frequency analysis on each piece of data divided by the data generation unit.

A failure symptom detection method for electric motor-provided equipment according to the present disclosure is a method for detecting a failure symptom of the electric motor-provided equipment including a load with an electric motor used as a motive-power source and a driving device which supplies power to the electric motor and drives the electric motor, the failure symptom detection method including: a first step of detecting current flowing to the electric motor; a second step of, from the current obtained in the first step, extracting current in an acceleration period until a constant rotational speed is reached after starting of the electric motor; a third step of dividing data of the current in the acceleration period extracted in the second step, into plural pieces of data, and performing frequency analysis on each divided piece of data, to generate a spectrum waveform; a fourth step of detecting an intensity value of a spectrum peak arising in a rotational frequency band of the electric motor, from the spectrum waveform obtained in the third step; a fifth step of comparing the intensity value of the spectrum peak obtained in the fourth step and a predetermined reference value; a sixth step of determining presence/absence of abnormality of the electric motor-provided equipment from a result of comparison in the fifth step; and a seventh step of reporting a result of determination in the sixth step to outside.

### Effect of the Invention

The failure symptom detection device for electric motor-provided equipment and the failure symptom detection method for electric motor-provided equipment according to the present disclosure can accurately detect a failure symptom of electric motor-provided equipment while being hardly influenced by noise and without adding an extra sensor.

### BRIEF DESCRIPTION OF THE DRAWINGS

FIG. 1 is a block diagram showing a schematic configuration of electric motor-provided equipment and a failure symptom detection device according to the present disclosure.

FIG. 2 is a block diagram showing a schematic configuration of an air conditioner as an example of electric motor-provided equipment according to embodiment 1 of the present disclosure.

FIG. 3 is a block diagram showing a configuration of a control device for controlling a driving device in electric motor-provided equipment according to embodiment 1 of the present disclosure.

FIG. 4 is a block diagram showing a schematic configuration of the failure symptom detection device according to embodiment 1 of the present disclosure.

FIG. 5 illustrates an example of a spectrum waveform obtained through frequency analysis on phase current.

FIG. 6 illustrates an example of a frequency spectrum waveform obtained through frequency analysis on q-axis current.

FIG. 7 is a flowchart showing a failure symptom detection method according to embodiment 1 of the present disclosure.

FIG. 8 is a waveform diagram showing temporal changes in a rotational speed and a current value when an electric motor is started, according to embodiment 1 of the present disclosure.

FIG. 9 illustrates an example of a frequency analysis result for q-axis current according to embodiment 1 of the present disclosure.

FIG. 10 is a block diagram showing a schematic configuration of electric motor-provided equipment and a failure symptom detection device according to embodiment 2 of the present disclosure.

FIG. 11 is a block diagram showing another schematic configuration of electric motor-provided equipment and a failure symptom detection device according to embodiment 2 of the present disclosure.

FIG. 12 is a block diagram showing a hardware configuration of a control device and the like according to the embodiments of the present disclosure.

### DESCRIPTION OF EMBODIMENTS

### Embodiment 1

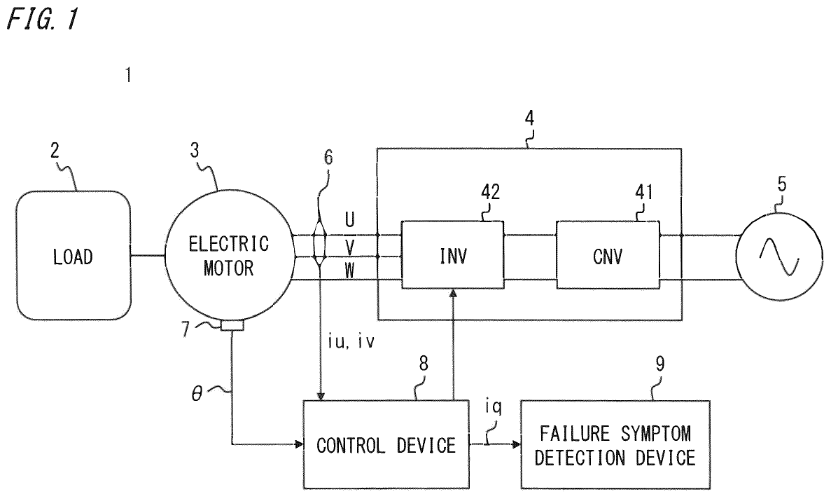

FIG. 1 is a block diagram showing a schematic configuration of electric motor-provided equipment and a failure symptom detection device according to the present disclosure.

Electric motor-provided equipment 1 includes a load 2 with an electric motor 3 used as a motive-power source, a driving device 4 which supplies power to the electric motor 3 and drives the electric motor 3, and a control device 8 for controlling operation of the driving device 4. An AC power supply 5 is connected to the driving device 4.

Here, the electric motor-provided equipment 1 is, for example, a water pump, a vacuum pump, a conveyor belt, an air conditioner, and the like. In embodiment 1, a case of taking an air conditioner as an example of the electric motor-provided equipment 1 and detecting a failure symptom thereof will be described.

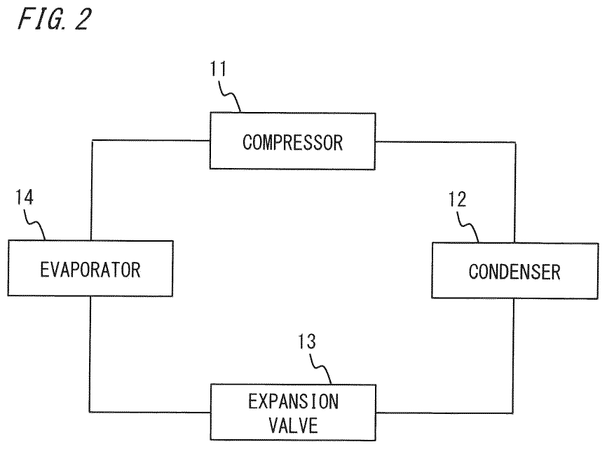

FIG. 2 is a block diagram showing a schematic configuration of an air conditioner as an example of electric motor-provided equipment according to embodiment 1 of the present disclosure.

The air conditioner operates as a refrigeration cycle apparatus and includes a compressor 11, a condenser 12, an expansion valve 13, and an evaporator 14. In this refrigeration cycle, a refrigerant circulates through the compressor 11, the condenser 12, the expansion valve 13, and the evaporator 14 in this order.

The compressor 11 compresses and discharges a gas refrigerant, and corresponds to the load 2 in FIG. 1. The compressor 11 compresses a gas refrigerant sucked using a driving force of the electric motor 3. The electric motor 3 is connected to a compression mechanism (not shown) that compresses the gas refrigerant in the refrigeration cycle. The condenser 12 condenses the gas refrigerant discharged from the compressor 11 and discharges a liquid refrigerant. The expansion valve 13 undergoes valve opening control to expand the refrigerant from the condenser 12, thus reducing the pressure thereof. The evaporator 14 evaporates a liquid-state refrigerant (liquid refrigerant) discharged from the expansion valve 13 and discharges a gas-state refrigerant (gas refrigerant).

The driving device 4 includes a converter 41 and an inverter 42. In FIG. 1, the converter is abbreviated as CNV and the inverter is abbreviated as INV.

The converter 41 receives AC current from the AC power supply 5, converts the AC current to DC current, and outputs the DC current to the inverter 42. The frequency of the AC power supply 5 is, for example, 50 Hz or 60 Hz.

The inverter 42 includes an inverter main circuit including a plurality of switching elements (not shown). The inverter 42 receives a pulse width modulation (PWM) signal from the control device 8 and performs ON/OFF switching of the switching elements to output three-phase currents (for U, V, W phases) to the electric motor 3 for driving the compressor 11 which is the load 2.

Of the three-phase currents (iu, iv, iw) outputted to the electric motor 3, for example, U-phase current iu and V-phase current iv are detected by a current sensor (current detection unit) 6 and outputted to the control device 8. A rotation angle θ of a rotor of the electric motor 3 is detected by an angle sensor 7 provided to the electric motor 3 and is outputted to the control device 8.

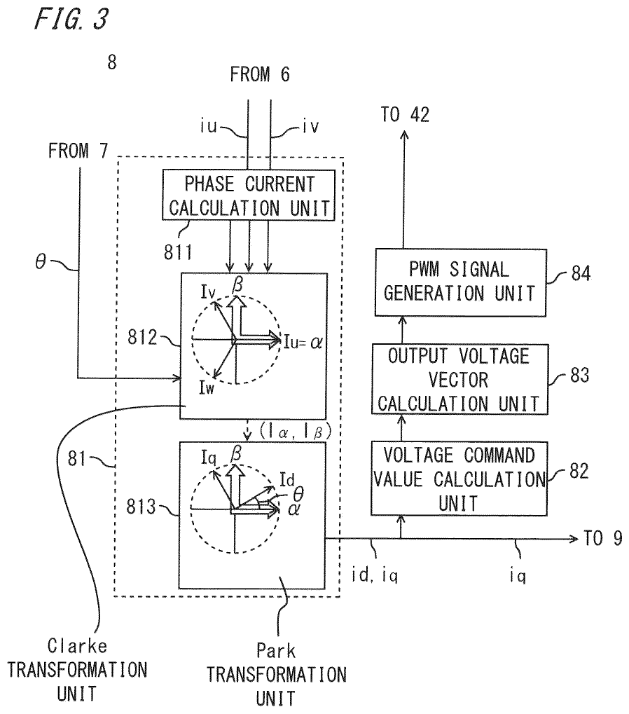

FIG. 3 is a block diagram showing a configuration of the control device for controlling operation of the driving device according to embodiment 1.

The control device 8 outputs a PWM signal to the inverter 42, to perform vector control, and includes a d-q transformation unit 81, a voltage command value calculation unit 82, an output voltage vector calculation unit 83, and a PWM signal generation unit 84. The d-q transformation unit 81 includes a phase current calculation unit 811, a Clarke transformation unit 812, and a Park transformation unit 813.

Here, the d-q transformation unit 81, the voltage command value calculation unit 82, the output voltage vector calculation unit 83, and the PWM signal generation unit 84 may be each implemented by dedicated hardware, or may be implemented by a computer such as a central processing unit (CPU) executing a program stored in a memory.

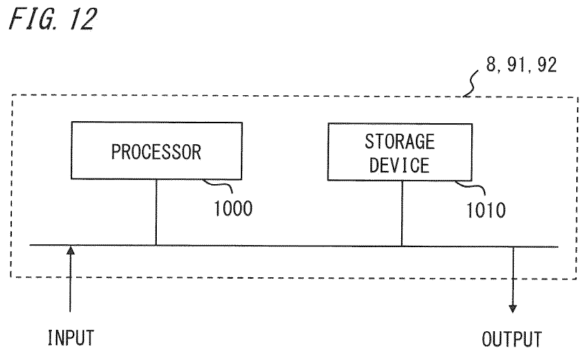

That is, the control device 8 is composed of a processor 1000 and a storage device 1010, as shown in a hardware example in FIG. 12. The storage device 1010 is provided with a volatile storage device such as a random access memory and a nonvolatile auxiliary storage device such as a flash memory (not shown). An auxiliary storage device of a hard disk may be provided instead of the flash memory. The processor 1000 executes a program inputted from the storage device 1010. In this case, the program is inputted from the auxiliary storage device to the processor 1000 via the volatile storage device. The processor 1000 may output data such as a calculation result to the volatile storage device of the storage device 1010 or may store such data into the auxiliary storage device via the volatile storage device.

The phase current calculation unit 811 receives the U-phase current iu and the V-phase current iv detected by the current sensor 6 and calculates W-phase current iw. Here, V-phase current iv and W-phase current iw may be detected to calculate U-phase current iu, or W-phase current iw and U-phase current iu may be detected to calculate V-phase current iv. The phase currents (iu, iv, iw) calculated by the phase current calculation unit 811 are outputted to the Clarke transformation unit 812 at the subsequent stage.

The phase currents (iu, iv, iw) change along with change in the rotation angle θ (mechanical angle) of the rotor of the electric motor 3. In the following description, the rotation angle θ is described as a value measured by the angle sensor 7. However, the angle sensor 7 is not an essential component in the present disclosure and the rotation angle θ may be calculated by another method. For example, the rotation angle θ may be calculated from the phase currents (iu, iv, iw) and a voltage command value as performed in known position sensorless control.

The Clarke transformation unit 812 transforms the phase currents (iu, iv, iw) to two-phase currents (iα, iβ) in a two-axis coordinate system (α-β coordinate system), and outputs the two-phase currents (iα, iβ) to the Park transformation unit 813 at the subsequent stage.

The Park transformation unit 813 receives the rotation angle θ of the rotor detected by the angle sensor 7 provided to the electric motor 3, and transforms the two-phase currents (iα, iβ) in the two-axis coordinate system (α-β coordinate system) to dq-axis currents (id, iq) corresponding to coordinates in a rotating coordinate system (d-q coordinate system). The Park transformation unit 813 outputs the values of the dq-axis currents (id, iq) to the voltage command value calculation unit 82 at the subsequent stage and outputs the value of the q-axis current iq to a failure symptom detection device 9.

Here, the d-axis current id is an excitation current component and produces a rotating magnetic field in the electric motor 3. The q-axis current iq is a torque current component and produces torque of the electric motor 3. The dq-axis currents (id, iq) correspond to values obtained when αβ-phase currents (iα, iβ) rotating by the rotation angle θ in the coordinate system at rest are measured in the rotating coordinate system that follows the rotation, and therefore the dq-axis currents (id, iq) have no change in the rotation angle θ.

The voltage command value calculation unit 82 calculates a difference between an actual voltage command value and the values of the dq-axis currents (id, iq) outputted from the Park transformation unit 813. Next, the output voltage vector calculation unit 83 calculates a correction value for correcting the calculated difference. Finally, the PWM signal generation unit 84 generates a PWM signal on the basis of the corrected voltage command value. Thus, the electric motor 3 is controlled into an ideal rotation state in accordance with the command value.

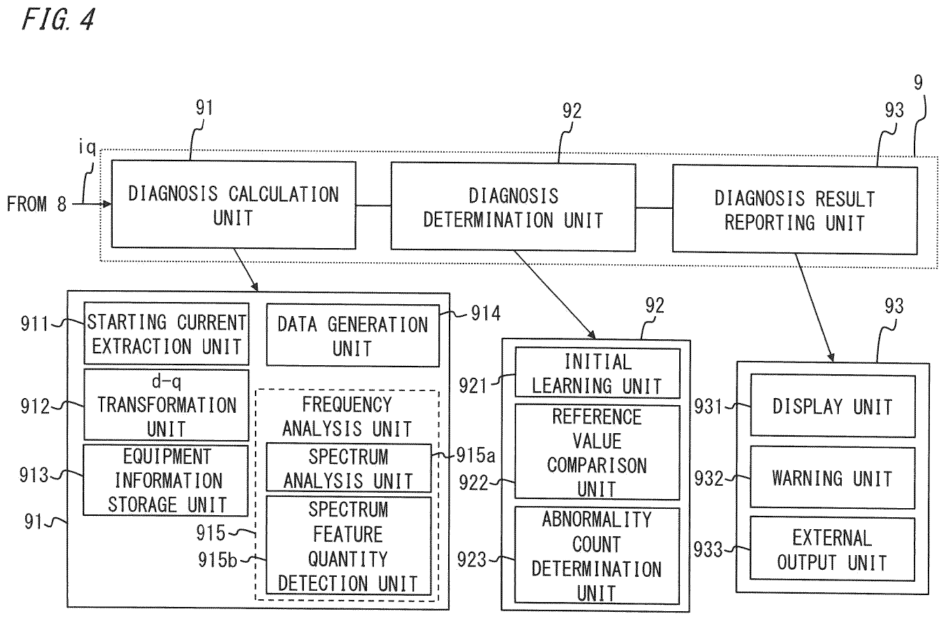

FIG. 4 is a block diagram showing a configuration of the failure symptom detection device according to embodiment 1.

The failure symptom detection device 9 is for detecting a failure symptom of the electric motor-provided equipment 1 (load 2 or electric motor 3) and includes a diagnosis calculation unit 91, a diagnosis determination unit 92, and a diagnosis result reporting unit 93.

Here, the diagnosis calculation unit 91 includes a starting current extraction unit 911, a d-q transformation unit 912, an equipment information storage unit 913, a data generation unit 914, and a frequency analysis unit 915. The frequency analysis unit 915 includes a spectrum analysis unit 915a and a spectrum feature quantity detection unit 915b.

Here, the d-q transformation unit 912 is a common unit shared as the d-q transformation unit 81 included in the control device 8, and uses the q-axis current iq obtained through d-q transformation of the phase currents (iu, iv, iw) calculated on the basis of a detection output from the current sensor 6 in the d-q transformation unit 81. Instead of being shared as the d-q transformation unit 81, it is also possible to perform d-q transformation by the d-q transformation unit 912 after detecting the phase currents (iu, iv, iw) by the current sensor 6.

The diagnosis determination unit 92 includes an initial learning unit 921, a reference value comparison unit 922, and an abnormality count determination unit 923.

The diagnosis result reporting unit 93 includes a display unit 931 such as a liquid crystal display, a warning unit 932 such as a lamp, and an external output unit 933 such as a printer.

Specific functions of the diagnosis calculation unit 91, the diagnosis determination unit 92, and the diagnosis result reporting unit 93 will become clear when operation processes in the respective units are described. The diagnosis calculation unit 91 and the diagnosis determination unit 92 may be implemented by dedicated hardware, or may be implemented by a computer such as a central processing unit (CPU) executing a program stored in a memory.

That is, the diagnosis calculation unit 91 and the diagnosis determination unit 92 are each composed of a processor 1000 and a storage device 1010, as shown in a hardware example in FIG. 12. The storage device 1010 is provided with a volatile storage device such as a random access memory and a nonvolatile auxiliary storage device such as a flash memory (not shown). An auxiliary storage device of a hard disk may be provided instead of the flash memory. The processor 1000 executes a program inputted from the storage device 1010. In this case, the program is inputted from the auxiliary storage device to the processor 1000 via the volatile storage device. The processor 1000 may output data such as a calculation result to the volatile storage device of the storage device 1010 or may store such data into the auxiliary storage device via the volatile storage device.

As current used for failure symptom detection, either of the dq-axis currents (id, iq), either of the αβ-phase currents (iα, iβ), or any of the phase currents (iu, iv, iw) may be used. In embodiment 1, failure symptom detection is performed using the q-axis current iq.

In a case where wear of a sliding part of the compression mechanism, which occupies most of abnormal cases of the compressor, has occurred, an air gap between the stator and the rotor of the electric motor vibrates, so that permeance changes. Therefore, each phase current is suitably used for failure symptom detection of the compressor. Also in a case where a bearing of the electric motor is worn, gap vibration occurs similarly, and therefore using each phase current is a suitable method for abnormality detection of the electric motor. For detection of each phase current, it suffices that the current sensor 6 is provided to a power supply cable, and another sensor need not be added. Thus, there is an advantage in terms of cost as well.

When the phase current flowing in the stator of the electric motor 3 or the q-axis current obtained through d-q transformation of the phase current is subjected to frequency analysis, characteristic spectrum peaks arise because current variation due to a failure symptom as described above occurs periodically.

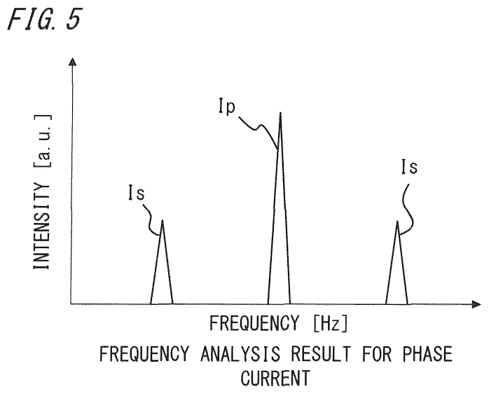

FIG. 5 illustrates an example of a spectrum waveform when the phase current (e.g., U-phase current iu) is subjected to frequency analysis.

In a case where current variation due to a failure symptom as described above occurs periodically, characteristic spectrum peaks Is as sideband waves arise on both sides near a peak Ip of the power supply frequency, at positions different among abnormality types. For example, in a case of abnormality such as misalignment or imbalance, sideband-wave peaks Is arise on both sides of the peak Ip of the power supply frequency, at positions away therefrom by a rotational frequency. In a case of abnormality due to a bearing of the electric motor 3, sideband-wave peaks Is arise on both sides of the power supply frequency, at positions away therefrom by a natural frequency of the bearing.

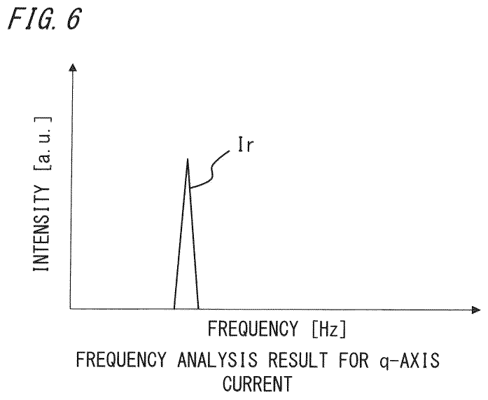

FIG. 6 illustrates an example of a spectrum waveform when the q-axis current iq is subjected to frequency analysis.

As in the case of FIG. 5, a characteristic spectrum peak arises at a position different among abnormality types. For example, in a case where whirling of an electric motor shaft occurs due to deterioration of a bearing or the like, a characteristic spectrum peak Ir arises in a rotational frequency band.

In general, in a method of diagnosing a device state through frequency analysis on a current signal of the electric motor 3, the analysis has been conventionally performed using the current signal under operation at a constant rotational speed. However, in a case where the load 2 has a mechanism part such as the compressor 11, a force having a rotational frequency component might be applied. In particular, in a scroll compressor, a rotational-frequency-component force is applied at a compression mechanism of a scroll part. Along with this, on a similar principle, a spectrum peak of a rotational frequency component arises in each phase current of the electric motor 3. Therefore, in such a case, it is difficult to discriminate between this spectrum peak and the characteristic spectrum peak due to abnormality of the sliding part of the compression mechanism, and thus there is a problem that a failure symptom cannot be detected accurately. The present disclosure is to solve such a problem.

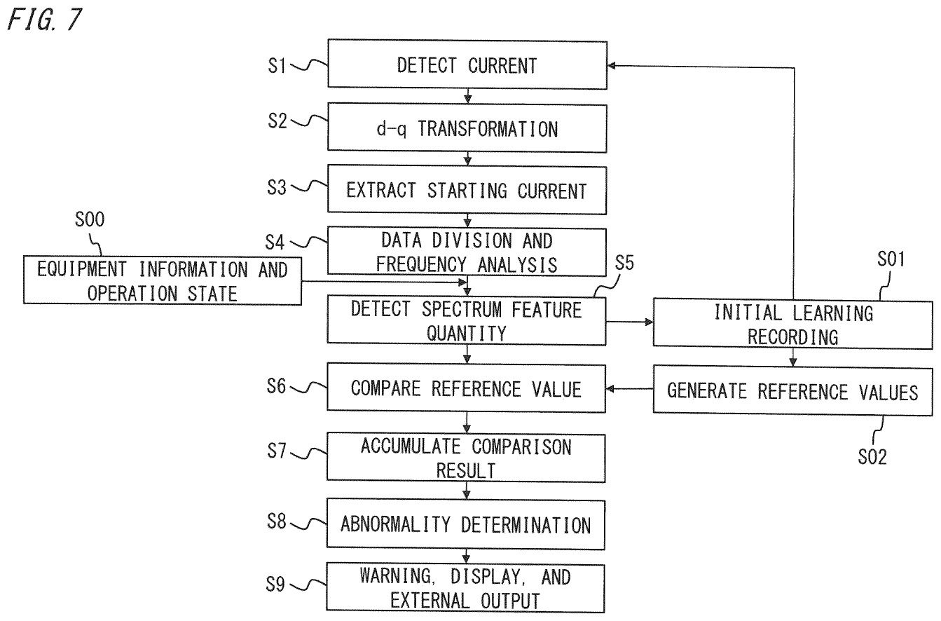

FIG. 7 is a flowchart showing a failure symptom detection method by the failure symptom detection device according to embodiment 1 of the present disclosure. In the drawing, reference characters S mean processing steps.

First, the d-q transformation unit 81 calculates the phase currents (iu, iv, iw) on the basis of a detection output from the current sensor 6 (step S1), and performs d-q transformation thereof (step S2).

Next, the starting current extraction unit 911 of the diagnosis calculation unit 91 extracts the q-axis current iq in an acceleration period until a constant rotational speed is reached after starting, except for a time just after starting of the electric motor 3 (step S3). The starting current extraction unit 911 may extract any of the phase currents (iu, iv, iw) in the acceleration period and then the d-q transformation unit 912 may perform d-q transformation of the extracted phase current.

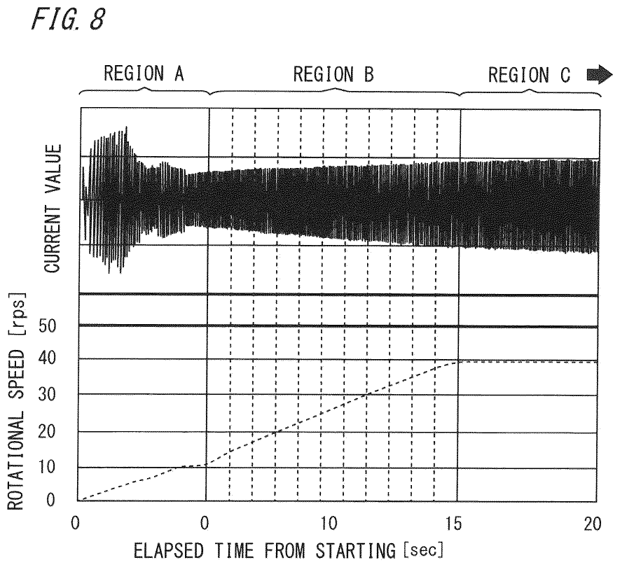

FIG. 8 is a waveform diagram showing temporal changes in the rotational speed and the current value when the electric motor is started. The lower-side graph shows temporal change in the rotational speed until the constant rotational speed is reached after starting of the electric motor 3, and the upper-side graph shows temporal change in the phase current (e.g., U-phase current iu) in this case.

A region A is a period in which inrush current flows just after starting of the electric motor 3, and the phase current greatly varies, leading to erroneous detection. Therefore, the region A is excluded in this analysis method.

A region B is the acceleration period until the rotational speed of the electric motor 3 reaches the constant value. The current in the acceleration period B is extracted and used as analysis data for failure symptom detection.

A region C is a period after the electric motor 3 reaches the constant rotational speed.

Then, after the q-axis current iq in the acceleration period B of the electric motor 3 is extracted by the starting current extraction unit 911, the data generation unit 914 divides data of the q-axis current iq into two or more pieces of data for data analysis on the extracted q-axis current iq (step S4). The division method is determined by the acceleration and the data sampling number. That is, in a case where the acceleration is great, a range where the power supply frequency and the spectrum peak vary is expanded, and therefore the number of divided pieces of data needs to be increased.

Next, the spectrum analysis unit 915a of the frequency analysis unit 915 performs frequency analysis on each of the plural pieces of data of the q-axis current iq divided by the data generation unit 914, to generate a spectrum waveform (step S4). As a method for the frequency analysis, for example, a current fast Fourier transform (FFT) analysis is known.

Meanwhile, in a variable-speed operation based on inverter driving, the number of pieces of data that can be used for frequency analysis is small and therefore there is a problem of being readily influenced by noise. In this regard, filter processing is performed so as to emphasize only feature components by applying compressed sensing to a current frequency characteristic having sparsity, whereby frequency analysis can be accurately performed even in a case of variable speed.

In the frequency analysis, without performing d-q transformation of the phase current, data obtained by detecting any of the phase currents (iu, iv, iw) may be directly divided into two or more pieces of data to perform frequency analysis.

As shown in the frequency spectrum waveforms in FIG. 5 and FIG. 6, whichever data of the phase current or the q-axis current iq is used, a spectrum peak of a rotational frequency component is detected due to eccentricity of the electric motor shaft based on abnormality of the sliding part of the compression mechanism. The rotational frequency component and the intensity value of the corresponding spectrum peak calculated by the diagnosis calculation unit 91 serve as index values for determining presence/absence of abnormality of the electric motor-provided equipment 1. Separately from the above processing steps S1 to S4, information about the power supply frequency, the number of poles, and the rated rotational speed which are specifications of the electric motor 3, and information about an operation mode with which driving operation greatly varies, are inputted and stored into the equipment information storage unit 913 (step S00).

The rotational speed under no load of the electric motor 3 can be calculated as 120·fs/p (fs: power supply frequency, p: number of poles). Therefore, the rotational speed of the electric motor 3 has a value between the rotational speed under no load and the rated rotational speed, and thus a rotational frequency band can be specified. In addition, for example, in the compressor 11, the operation mode greatly differs between summer and winter. In this way, analysis data can be associated with each of a plurality of operation modes.

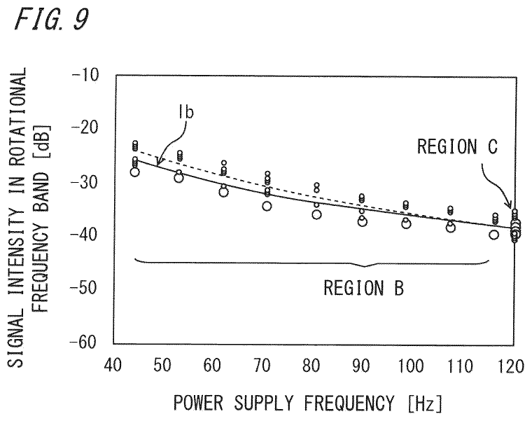

In the failure symptom detection device 9, in a case of determining presence/absence of a failure symptom in the electric motor-provided equipment 1 (load 2 or electric motor 3), as a premise therefor, data obtained initially at the start of diagnosis, i.e., in a state in which the electric motor-provided equipment 1 is new and has not been deteriorated due to aging yet, is regarded as normal, and from the normal data, reference values Ib for determining presence/absence of a failure symptom are set for respective power supply frequencies (see solid line in FIG. 9).

For this purpose, first, initially at the start of diagnosis, the spectrum feature quantity detection unit 915b detects intensity values of spectrum peaks arising in a rotational frequency band, which are obtained as a result of frequency analysis performed on each of the plural pieces of data divided in step S4 (step S5).

Subsequently, from initial data obtained through operation in each of set operation modes, the intensity values of spectrum peaks detected in step S5 and information about the operation modes and the power supply frequencies (or the rotational frequencies calculated from the power supply frequencies) stored in the equipment information storage unit 133, are associated with each other and then stored as learning data in the initial learning unit 921 (step S01).

Subsequently, the initial learning unit 921 generates the reference values Ib for the respective power supply frequencies from the stored learning data (step S02). For example, the reference values Ib are set at values such as two or three times a variation σ of the learning data, whereby an influence due to operation variation can be excluded. The reference values Ib may be set from outside.

As described above, after initial learning in which the initial learning unit 921 generates the reference values Ib for the respective power supply frequencies using initial data at the start of diagnosis as normal data is finished, next, actual diagnosis is started.

Then, regarding the spectrum peaks arising in the rotational frequency band, which are obtained as a result of frequency analysis performed on each of the plural pieces of data divided in the above step S4, when the intensity values are detected in step S5, the reference value comparison unit 922 compares each detected intensity value with the reference value Ib set by the initial learning unit 921 as described above (step S6).

As a result of comparison by the reference value comparison unit 922, when the detected intensity value exceeds the reference value Ib, the abnormality count determination unit 923 determines that there is abnormality and stores the comparison result for each of the divided pieces of data (step S7).

Then, in a case where abnormality determination is consecutively repeated for a specific rotational speed and a predetermined threshold is exceeded, the abnormality count determination unit 923 determines that the electric motor-provided equipment 1 has a failure symptom, thus determining that there is abnormality (step S8).

FIG. 9 illustrates an example of a result of frequency analysis on the q-axis current in a case where abnormality has occurred at the sliding part of the compression mechanism of the compressor 11.

In FIG. 9, filled circles indicate a result of initial learning using data obtained initially at the start of diagnosis as normal data, and a solid line indicates a result of initial learning performed by providing the reference values Ib for the respective power supply frequencies from the normal data. In addition, blank circles indicate data obtained after deterioration by aging and determined as abnormality, and a broken line indicates an average value thereof.

In operation of the electric motor 3, acceleration is performed to reach a power supply frequency of 120 Hz, and thereafter, operation at a constant rotational speed is performed in a state of 120 Hz. A rated rotational speed N (r/min) of the electric motor 3 is calculated as 120·fs/p (fs: power supply frequency, p: number of poles (6)), and as the power supply frequency increases, the rotational speed also increases proportionally.

As is found from the result shown in FIG. 9, in comparison between the reference value Ib and data obtained when the electric motor-provided equipment 1 has been deteriorated due to aging after continuous usage, it is difficult to perform abnormality detection in the constant-rotational-speed operation (120 Hz), but it is possible to perform discrimination for whether abnormal or normal in a low-speed region (40 Hz to 80 Hz) during acceleration from starting.

Thus, a force applied to the electric motor shaft by the scroll part of the compressor and a force applied to the electric motor shaft due to failure are clearly discriminated from each other, whereby a spectrum peak arising due to the failure can be detected.

In a case where, in the above step S8, the abnormality count determination unit 923 determines that the electric motor-provided equipment 1 (load 2 or electric motor 3) has a failure symptom and thus determines that there is abnormality, the diagnosis result reporting unit 93 accordingly causes the display unit 931 to display abnormality of the electric motor-provided equipment 1 as an alarm on a screen and causes the warning unit 932 to issue a warning. In addition, processing such as printing out is performed by the external output unit 933 (step S9).

In embodiment 1, the failure symptom detection method has been described using the electric motor-provided equipment 1 in which the load 2 is the compressor 11, as an example. However, without limitation thereto, even if the load 2 is other than the compressor 11, the present disclosure is applicable to the electric motor-provided equipment 1 (e.g., a vacuum pump, a water pump, or a conveyor belt) for which failure symptom detection is difficult because a component other than that due to abnormality is superimposed.

In embodiment 1, the configuration in which the control device 8 and the failure symptom detection device 9 are provided as independent devices has been described as a premise. However, the control device 8 and the failure symptom detection device 9 may be combined integrally as a single device.

As described above, according to embodiment 1, a failure symptom is detected through analysis on current signals obtained by the control device 8 which controls operation of the electric motor-provided equipment 1. Thus, it becomes possible to assuredly detect a failure symptom without adding an extra sensor.

By using data in the acceleration period (region B in FIG. 8) until reaching a constant stable rotational speed from transitional variation occurring just after starting of the electric motor 3, it becomes possible to assuredly detect a failure symptom of a sliding part such as a bearing for which detection has been conventionally difficult due to the operation state of the electric motor-provided equipment 1.

### Embodiment 2

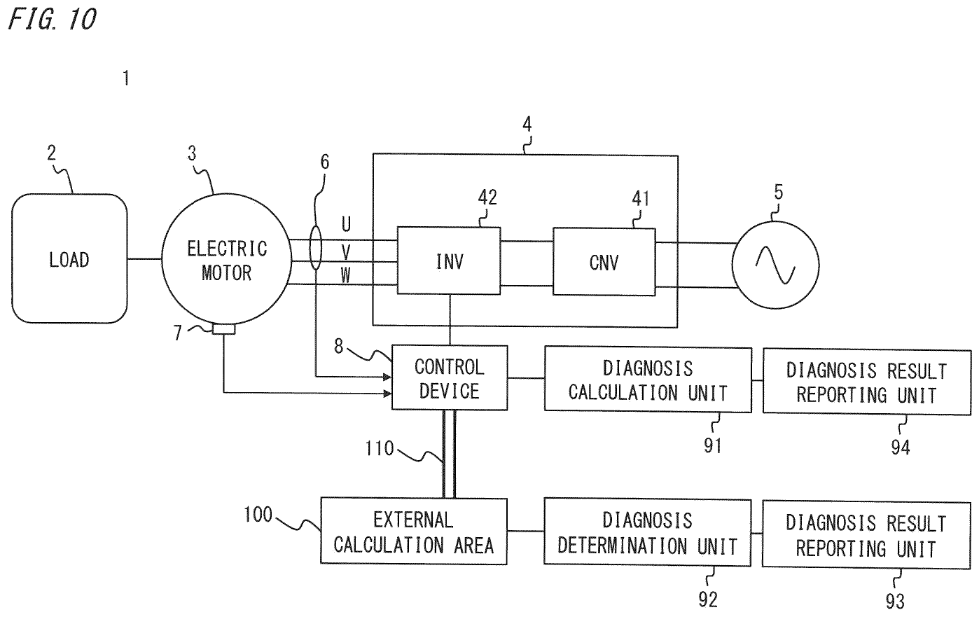

FIG. 10 is a block diagram showing a schematic configuration of electric motor-provided equipment and a failure symptom detection device according to embodiment 2 of the present disclosure.

In the configuration shown in FIG. 10, the diagnosis calculation unit 91 and a diagnosis result reporting unit 94 are connected to the control device 8 of the electric motor-provided equipment 1, and meanwhile, the diagnosis determination unit 92 and the diagnosis result reporting unit 93 are provided on an external calculation area 100 side such as a personal computer (PC), a server, or a cloud. Then, the control device 8 and the external calculation area 100 are connected via a communication network 110 such as Ethernet, whereby data is mutually transmitted/received via the communication network 110.

The diagnosis calculation unit 91 connected to the control device 8 calculates index values (a rotational frequency component and the intensity value of a corresponding spectrum peak) for determination for presence/absence of abnormality of the electric motor-provided equipment 1, and the calculation result is transmitted to the external calculation area 100 side via the communication network 110. The diagnosis determination unit 92 provided on the external calculation area 100 side accumulates the transmitted data, performs diagnosis determination on the basis of the data, and outputs a result thereof to the diagnosis result reporting unit 93. In a case where the diagnosis determination unit 92 determines that there is abnormality, information thereof is transmitted to the control device 8 via the communication network 110. Thus, not only the diagnosis result reporting unit 93 provided on the external calculation area 100 side but also the diagnosis result reporting unit 94 provided on the control device 8 side of the electric motor-provided equipment 1 can perform processing such as issuing a warning and performing alarm display, individually.

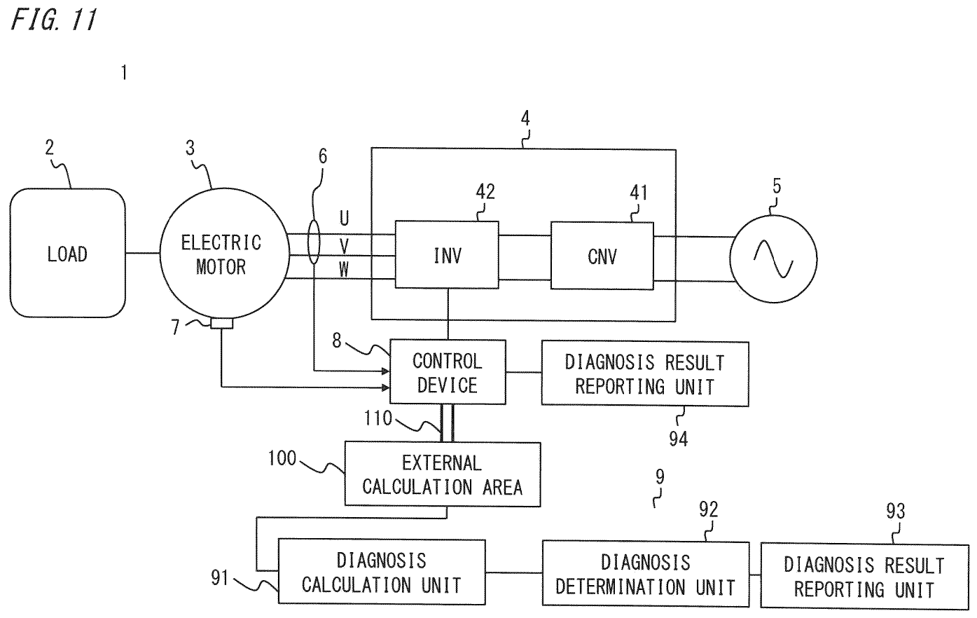

FIG. 11 is a block diagram showing another schematic configuration of electric motor-provided equipment and a failure symptom detection device according to embodiment 2 of the present disclosure.

In the configuration shown in FIG. 11, the diagnosis result reporting unit 94 is provided to the control device 8 of the electric motor-provided equipment 1, and meanwhile, the diagnosis calculation unit 91, the diagnosis determination unit 92, and the diagnosis result reporting unit 93 composing the failure symptom detection device 9 are provided on the external calculation area 100 side. Then, the control device 8 and the external calculation area 100 are connected via the communication network 110 such as Ethernet, whereby data is mutually transmitted/received via the communication network 110.

Data of current signals acquired by the control device 8 is transmitted to the external calculation area 100 side via the communication network 110. The failure symptom detection device 9 provided in the external calculation area 100 causes the diagnosis calculation unit 91 to extract index values for determination for presence/absence of abnormality, through frequency analysis, and causes the diagnosis determination unit 92 to accumulate data and perform diagnosis determination and output a result thereof to the diagnosis result reporting unit 93. In a case where the diagnosis determination unit 92 determines that there is abnormality, information thereof is transmitted to the control device 8 via the communication network 110. Thus, not only the diagnosis result reporting unit 93 provided on the external calculation area 100 side but also the diagnosis result reporting unit 94 provided on the control device 8 side of the electric motor-provided equipment 1 can perform processing such as issuing a warning and performing alarm display, individually.

Although the disclosure is described above in terms of various exemplary embodiments 1 and 2, it should be understood that the various features, aspects, and functionality described in these embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 electric motor-provided equipment (air conditioner)
2 load
3 electric motor
4 driving device
41 converter
42 inverter
5 AC power supply
11 compressor (load)
12 condenser
13 expansion valve
14 evaporator
6 current sensor
7 angle sensor
8 control device
81 d-q transformation unit
9 failure symptom detection device
91 diagnosis calculation unit
911 starting current extraction unit
912 d-q transformation unit
913 equipment information storage unit
914 data generation unit
915 frequency analysis unit
915a spectrum analysis unit
915b spectrum feature quantity detection unit
92 diagnosis determination unit
921 initial learning unit
022 reference value comparison unit
923 abnormality count determination unit
93 diagnosis result reporting unit
931 display unit
932 warning unit
933 external output unit

1. A failure symptom detection device for electric motor-provided equipment, which detects a failure symptom of the electric motor-provided equipment including a load with an electric motor used as a motive-power source and a driving device which supplies power to the electric motor and drives the electric motor, the failure symptom detection device comprising:
a current detector which detects current flowing from the driving device to the electric motor;
a diagnosis calculation circuitry which calculates an index value for determination for presence/absence of abnormality of the electric motor-provided equipment, on the basis of a result of detection by the current detector;
a diagnosis determination circuitry which determines presence/absence of abnormality of the electric motor-provided equipment on the basis of a result of calculation by the diagnosis calculation circuitry; and
a diagnosis result reporting circuitry which reports a result of diagnosis determined by the diagnosis determination circuitry, to outside, wherein
the diagnosis calculation circuitry includes
a starting current extraction circuitry which, from the current detected by the current detector, extracts current in an acceleration period until a constant rotational speed is reached after starting of the electric motor,
a data generation circuitry which divides data of the current in the acceleration period extracted by the starting current extraction circuitry, into plural pieces of data, and
a frequency analysis circuitry which performs frequency analysis on each piece of data divided by the data generation circuitry.

2. The failure symptom detection device for the electric motor-provided equipment according to claim 1, wherein
the frequency analysis circuitry includes
a spectrum analysis circuitry which performs frequency analysis for current frequencies of each piece of data divided by the data generation circuitry, to generate a spectrum waveform, and
a spectrum feature quantity detection circuitry which detects, as the index value, an intensity value of a spectrum peak in a rotational frequency band of the electric motor on the basis of the spectrum waveform analyzed by the spectrum analysis circuitry.

3. The failure symptom detection device for the electric motor-provided equipment according to claim 2, further comprising a d-q transformation circuitry which performs d-q transformation of phase currents detected by the current detector, wherein
from q-axis current obtained through d-q transformation by the d-q transformation circuitry, the starting current extraction circuitry extracts q-axis current in the acceleration period until the constant rotational speed is reached after starting of the electric motor.

4. The failure symptom detection device for the electric motor-provided equipment according to claim 2, wherein
from phase current detected by the current detector, without performing d-q transformation thereof, the starting current extraction circuitry extracts phase current in the acceleration period until the constant rotational speed is reached after starting of the electric motor.

5. The failure symptom detection device for the electric motor-provided equipment according to claim 2, wherein
the diagnosis determination circuitry includes
an initial learning circuitry which stores an initial analysis result serving as a reference value for determination comparison,
a reference value comparison circuitry which compares the reference value stored in the initial learning circuitry and the intensity value of the spectrum peak in the rotational frequency band of the electric motor detected by the spectrum feature quantity detection circuitry, and
an abnormality count determination circuitry which counts a number of times the reference value comparison circuitry determines that the intensity value exceeds the reference value and thus there is abnormality, and determines a diagnosis result in accordance with the counted number of abnormality determinations.

6. The failure symptom detection device for the electric motor-provided equipment according to claim 5, wherein
the initial learning circuitry learns the reference values under respective operation conditions corresponding to various operation patterns and outside environments of the electric motor-provided equipment, and the reference value comparison circuitry performs comparison with the reference value stored in the initial learning circuitry in accordance with the operation condition.

7. The failure symptom detection device for the electric motor-provided equipment according to claim 1, wherein
the diagnosis result reporting circuitry includes at least one of a display which displays presence/absence of abnormality of the electric motor-provided equipment, an external output circuitry which outputs the presence/absence of abnormality to outside, and a warning circuitry which issues a warning in a case where there is abnormality of the electric motor-provided equipment.

8. A failure symptom detection method for electric motor-provided equipment, for detecting a failure symptom of the electric motor-provided equipment including a load with an electric motor used as a motive-power source and a driving device which supplies power to the electric motor and drives the electric motor, the failure symptom detection method comprising:
a first step of detecting current flowing to the electric motor;
a second step of, from the current obtained in the first step, extracting current in an acceleration period until a constant rotational speed is reached after starting of the electric motor;
a third step of dividing data of the current in the acceleration period extracted in the second step, into plural pieces of data, and performing frequency analysis on each divided piece of data, to generate a spectrum waveform;
a fourth step of detecting a feature component of a spectrum peak arising in a rotational frequency band of the electric motor, from the spectrum waveform obtained in the third step;
a fifth step of comparing an intensity value of the spectrum peak obtained in the fourth step and a predetermined reference value;
a sixth step of determining presence/absence of abnormality of the electric motor-provided equipment from a result of comparison in the fifth step; and
a seventh step of reporting a result of determination in the sixth step to outside.

9. The failure symptom detection method for the electric motor-provided equipment according to claim 8, further comprising an eighth step of performing d-q transformation of phase current flowing to the electric motor and detected in the first step, wherein
in the second step, q-axis current obtained in the eighth step in the acceleration period until the constant rotational speed is reached after starting of the electric motor, is extracted, and
in the third step, data of the q-axis current extracted in the second step is divided into plural pieces of data, and frequency analysis is performed on the divided pieces of data.

10. The failure symptom detection method for the electric motor-provided equipment according to claim 8, wherein
in the second step, phase current in the acceleration period until the constant rotational speed is reached after starting of the electric motor is extracted without being subjected to d-q transformation, and
in the third step, data of the phase current extracted in the second step is divided into plural pieces of data, and frequency analysis is performed on each divided piece of data, to generate a spectrum waveform.

11. The failure symptom detection method for the electric motor-provided equipment according to claim 8, wherein
in performing the frequency analysis in the third step, filter processing is performed so as to emphasize only a feature component by applying compressed sensing to a current frequency characteristic having sparsity.

12. The failure symptom detection method for the electric motor-provided equipment according to claim 8, wherein
in the fifth step, prior to comparing the intensity value of the spectrum peak with the reference value, initial learning is performed to store an initial analysis result as the reference value for determination comparison in advance, and
in the sixth step, a number of times it is determined from the result of comparison in the fifth step that the intensity value of the spectrum peak exceeds the reference value obtained through the initial learning and thus there is abnormality, is counted, and a diagnosis result is determined in accordance with the counted number of abnormality determinations.

13. The failure symptom detection method for the electric motor-provided equipment according to claim 12, wherein
in the initial learning, the reference values are learned under respective operation conditions corresponding to various operation patterns and outside environments of the electric motor-provided equipment.

14. A failure symptom detection device for electric motor-provided equipment, which detects a failure symptom of the electric motor-provided equipment including a load with an electric motor used as a motive-power source and a driving device which supplies power to the electric motor and drives the electric motor, the failure symptom detection device comprising:
a current detector which detects current flowing from the driving device to the electric motor;
a diagnosis calculation circuitry which calculates an index value for determination for presence/absence of abnormality of the electric motor-provided equipment, on the basis of a result of detection by the current detector;
a diagnosis determination circuitry which determines presence/absence of abnormality of the electric motor-provided equipment on the basis of a result of calculation by the diagnosis calculation circuitry; and
a diagnosis result reporting circuitry which reports a result of diagnosis determined by the diagnosis determination circuitry, to outside, wherein
the diagnosis calculation circuitry includes a frequency analysis circuitry which performs frequency analysis on, of the current detected by the current detector, current data in at least a part of an acceleration period until a constant rotational speed is reached after starting of the electric motor.

15. A failure symptom detection method for electric motor-provided equipment, for detecting a failure symptom of the electric motor-provided equipment including a load with an electric motor used as a motive-power source and a driving device which supplies power to the electric motor and drives the electric motor, the failure symptom detection method comprising:
a first step of detecting current flowing to the electric motor;
a second step of performing frequency analysis on, of the current obtained in the first step, current data in at least a part of an acceleration period until a constant rotational speed is reached after starting of the electric motor, to generate a spectrum waveform;
a third step of detecting a feature component of a spectrum peak arising in a rotational frequency band of the electric motor, from the spectrum waveform obtained in the second step;
a fourth step of comparing an intensity value of the spectrum peak obtained in the third step and a predetermined reference value;
a fifth step of determining presence/absence of abnormality of the electric motor-provided equipment from a result of comparison in the fourth step; and
a sixth step of reporting a result of determination in the fifth step to outside.

16. The failure symptom detection device for the electric motor-provided equipment according to claim 14, wherein
the frequency analysis circuitry includes
a spectrum analysis circuitry which performs frequency analysis for frequencies of the current data, to generate a spectrum waveform, and
a spectrum feature quantity detection circuitry which detects, as the index value, an intensity value of a spectrum peak in a rotational frequency band of the electric motor on the basis of the spectrum waveform analyzed by the spectrum analysis circuitry.

17. The failure symptom detection device for the electric motor-provided equipment according to claim 16, wherein the diagnosis calculation circuitry includes a d-q transformation circuitry which performs d-q transformation of phase currents detected by the current detector, and
from q-axis current obtained through d-q transformation by the d-q transformation circuitry, extracts q-axis current in at least a part of the acceleration period until a constant rotational speed is reached after starting of the electric motor.

18. The failure symptom detection device for the electric motor-provided equipment according to claim 16,
wherein the diagnosis calculation circuitry, from phase current detected by the current detector, without performing d-q transformation thereof, extracts phase current in at least a part of the acceleration period until a constant rotational speed is reached after starting of the electric motor.

19. The failure symptom detection device for the electric motor-provided equipment according to claim 16, wherein
the diagnosis determination circuitry includes
an initial learning circuitry which stores an initial analysis result serving as a reference value for determination comparison,
a reference value comparison circuitry which compares the reference value stored in the initial learning circuitry and the intensity value of the spectrum peak in the rotational frequency band of the electric motor detected by the spectrum feature quantity detection circuitry, and
an abnormality count determination circuitry which counts a number of times the reference value comparison circuitry determines that the intensity value exceeds the reference value and thus there is abnormality, and determines a diagnosis result in accordance with the counted number of abnormality determinations.

20. The failure symptom detection device for the electric motor-provided equipment according to claim 19, wherein
the initial learning circuitry learns the reference values under respective operation conditions corresponding to various operation patterns and outside environments of the electric motor-provided equipment, and the reference value comparison circuitry performs comparison with the reference value stored in the initial learning circuitry in accordance with the operation condition.
